(19) United States
(12) Patent Application Publication
(10) Pub. No.: US 2014/0047966 A1
(43) Pub. Date: Feb. 20, 2014

(54) DISCHARGE MECHANISM, SUBSTITUTE ROUTE MEMBER, PART SUPPLY MECHANISM, AND METHOD OF MANUFACTURING SUBSTRATE

(71) Applicant: Sony Corporation, Tokyo (JP)

(72) Inventors: Kenichi Oowada, Saitama (JP); Katsuya Takahara, Saitama (JP)

(73) Assignee: Sony Corporation, Tokyo (JP)

(21) Appl. No.: 13/964,340

(22) Filed: Aug. 12, 2013

(30) Foreign Application Priority Data
Aug. 17, 2012 (JP) 2012-180831

(51) Int. Cl. B26D 1/01

(52) U.S. Cl. CPC B26D 1/015
USPC 83/448; 29/401.1

(57) ABSTRACT

A discharge mechanism includes a discharge route, a cutting unit, and a substitute route member. Through the discharge route, a waste tape, which is a carrier tape generated after an electronic component is taken out therefrom, passes. The cutting unit has a cutting portion which cuts the waste tape which passes through the discharge route, forms a part of the discharge route, and is capable of being attached to and detached from the discharge route. The substitute route member is configured to substitute a gap of the discharge route which is generated when the cutting unit is detached from the discharge route.

### BACKGROUND

The present disclosure relates to a part supply mechanism that supplies an electronic component to be mounted on a substrate, and in particular, relates to a discharge mechanism that discharges a vacant carrier tape (waste tape) generated by taking out an electronic component from a carrier tape.

From the past, a mounting apparatus that mounts various electronic components such as a resistor and a capacitor on a substrate is widely known. The mounting apparatus of this type generally includes a conveyance mechanism that conveys a substrate, a supply mechanism that supplies an electronic component, a mounting head that sucks the electronic component supplied from the supply mechanism with a suction nozzle and mounts the sucked electronic component on a substrate, and the like.

The supply mechanism includes a plurality of tape cassettes arranged along a transverse direction, for example. The tape cassettes each accommodate a carrier tape that stores electronic components. The tape cassette feeds the carrier tape by step feeding, thereby feeding the electronic components stored in the carrier tape to a suction position.

When the electronic components are sucked by the suction nozzle, and the electronic components are taken out from the carrier tape, the carrier tape becomes vacant in a part from which the electronic components are taken out. The vacant carrier tape is fed to the front of the tape cassette as a waste tape.

To cut the waste tape into a predetermined length, a tape cutting apparatus may be provided to the supply mechanism in some cases (see, for example, Japanese Patent Application Laid-open No. 2008-218657). The waste tapes cut by the tape cutting apparatus are collected in a dust box or the like and are discarded by a user after that.

### SUMMARY

In the case where the tape cutting apparatus is broken, or in the case where the tape cutting apparatus is subjected to maintenance, it is necessary to detach the tape cutting apparatus from the supply mechanism. The tape cutting apparatus is disposed on the midway of a discharge route through which the waste tape is discharged, so when the tape cutting apparatus is detached, a gap is generated in a part where the tape cutting apparatus is detached in the discharge route.

If the production of a substrate is continued in the state where the gap is formed in the discharge route, there arises a problem in that the waste tape gets out of the discharge route. In this case, the waste tape that exits the discharge route may be entangled in another mechanism. For this reason, in the case where it is necessary to detach the tape cutting apparatus, an operation of the mounting apparatus has to be stopped, which raises a problem in that the production of the substrate by the mounting apparatus stops.

In view of the above-mentioned circumstances, it is desirable to provide a technique such as a discharge mechanism capable of securing a discharge route in the case where a cutting unit is necessary to be detached from the discharge route.

According to an embodiment of the present disclosure, there is provided a discharge mechanism including a discharge route, a cutting unit, and a substitute route member.

Through the discharge route, a waste tape, which is a carrier tape generated after an electronic component is taken out therefrom, passes.

The cutting unit has a cutting portion which cuts the waste tape which passes through the discharge route, forms a part of the discharge route, and is capable of being attached to and detached from the discharge route.

The substitute route member is configured to close a gap of the discharge route which is generated when the cutting unit is detached from the discharge route.

In the embodiment of the present disclosure, the gap generated when the cutting unit is detached from the discharge route can be closed by the substitute route member. Therefore, even in the case where the cutting unit has to be detached from the discharge route, it is possible to secure the discharge route. As a result, it is possible to continue to supply the electronic components from the carrier tape and continue production of substrates, if the cutting unit is detached from the discharge route.

In the discharge mechanism, the substitute route member may serve as a discharge route member.

When the cutting unit is attached to the discharge route, the substitute route member forms another part of the discharge route on a position adjacent to the cutting unit. When the cutting unit is detached from the discharge route, one of an entire substitute route member and a part thereof is moved toward the gap of the discharge route, and the part thereof closes the gap of the discharge route as the substitute route member.

In the embodiment of the present disclosure, by moving the entire substitute route member or the part thereof toward the gap of the discharge route, it is possible to close the gap of the discharge route.

In the discharge mechanism, the discharge route member may be a downstream side route member that forms another part of the discharge route on a downstream position of the discharge route from the cutting unit, when the cutting unit is attached to the discharge route.

In the discharge mechanism, when the cutting unit is detached from the discharge route, the downstream side route member may be entirely moved toward the gap of the discharge route, and a part of the downstream side route member may close the gap of the discharge route as the substitute route member.

In the embodiment of the present disclosure, by moving the entire downstream side route member toward the gap of the discharge route, it is possible to close the gap of the discharge route. In the present disclosure, there is no need to especially provide an additional substitute route member, so it is possible to cut the cost.

In the embodiment of the present disclosure, the downstream side route member may include a downstream side route member main body and a movement member. The movement member is movably provided to the downstream side route member main body and is moved toward the gap of the discharge route to close the gap of the discharge route as the substitute route member, when the cutting unit is detached from the discharge route.

In the embodiment of the present disclosure, b moving the movement member toward the gap of the discharge route, it is possible to easily close the gap of the discharge route.

In the discharge mechanism, the movement member may be provided slidably with respect to the downstream side route member main body.

In the discharge mechanism, the movement member is provided on an inner circumferential side of the downstream side route member main body slidably with respect to the downstream side route member main body.

As a result, it is possible to prevent the waste tape from clogging in the route.

In the discharge mechanism, the discharge route member may be an upstream side route member that forms another part of the discharge route on an upstream position of the discharge route from the cutting unit, when the cutting unit is attached to the discharge route.

In the discharge mechanism, the upstream side route member may include an upstream side route member main body and a movement member. The movement member is movably provided to the upstream side route member main body and is moved toward the gap of the discharge route to close the gap of the discharge route as the substitute route member, when the cutting unit is detached from the discharge route.

In the embodiment of the present disclosure, by moving the movement member toward the gap of the discharge route, it is possible to easily close the gap of the discharge route.

In the discharge mechanism, the movement member may be provided slidably with respect to the upstream side route member main body.

In the discharge mechanism, the movement member may be provided on an outer circumferential side of the upstream side route member main body slidably with respect to the upstream side route member main body.

As a result, it is possible to prevent the waste tape from clogging in the route.

According to another embodiment of the present disclosure, there is provided a substitute route member. The substitute route member closes a gap of a discharge route which is generated when a cutting unit is detached from the discharge route. The cutting unit has a cutting portion that cuts a waste tape as a carrier tape generated after an electronic component is taken therefrom when the waste tape passes through the discharge route, forms a part of the discharge route, and is capable of being attached to and detached from the discharge route.

According to another embodiment of the present disclosure, there is provided a part supply mechanism including a supply mechanism main body and a discharge mechanism.

The supply mechanism main body is configured to supply an electronic component accommodated in a carrier tape.

The discharge mechanism includes a discharge route, a cutting unit, and a substitute route member.

Through the discharge route, a waste tape, which is a carrier tape generated after an electronic component is taken out therefrom, passes.

The cutting unit has a cutting portion which cuts the waste tape which passes through the discharge route, forms a part of the discharge route, and is capable of being attached to and detached from the discharge route.

The substitute route member closes a gap of the discharge route which is generated when the cutting unit is detached from the discharge route.

According to another embodiment of the present disclosure, there is provided a method of manufacturing a substitute including supplying an electronic component to be mounted on a substrate. The electronic component is accommodated in a carrier tape.

A cutting unit that has a cutting portion which cuts a waste tape when the waste tape passes through the discharge route, forms a part of the discharge route, and is capable of being attached to and detached from the discharge route is detached from a discharge route. The waste tape is a carrier tape generated after the electronic component is taken out therefrom by the supplying.

A gap of the discharge route which is generated when the cutting unit is detached from the discharge route is closed by a substitute route member, to continue to manufacture the substrate.

As described above, according to the embodiments of the present disclosure, it is possible to provide the technology such as the discharge mechanism capable of securing the discharge route in the case where the cutting unit has to be detached from the discharge route.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a front view showing a mounting apparatus;

FIG. 2 is a top view showing the mounting apparatus;

FIG. 3 is a perspective view showing an example of a part supply mechanism;

FIG. 4 is a schematic side cross-sectional view showing the part supply mechanism;

FIG. 5 is a side enlarged view of a cutting unit of the part supply mechanism;

FIG. 6 is a perspective view showing the structure of a carrier tape;

FIG. 7 is a perspective view showing the part supply mechanism and shows a position of duct when the cutting unit is detached from a supply mechanism main body;

FIG. 8 is a schematic side cross-sectional view showing the part supply mechanism and shows the position of the duct when the cutting unit is detached from the supply mechanism main body;

FIG. 9 is a diagram showing an example in the case where an outer circumferential size of an upper end portion of the duct is formed to be smaller than an inner circumferential size of a lower end portion of a shooter;

FIG. 10A is a schematic side view showing a discharge mechanism according to another embodiment of the present disclosure and shows a discharge route when the cutting unit is attached;

FIG. 10B is a schematic side view showing the discharge mechanism and shows the discharge route when the cutting unit is detached;

FIG. 11 is a diagram showing an example in which an outer circumferential size of an upper end portion of a movement member is formed to be smaller than the inner circumferential size of the lower end portion of the shooter;

FIG. 12A is a schematic side view showing a discharge mechanism according to another embodiment of the present disclosure and shows a discharge route when a cutting unit is attached;

FIG. 12B is a schematic side view showing the discharge mechanism and shows the discharge route when the cutting unit is detached; and

FIG. 13 is a diagram showing an example in which a substitute route member is provided separately from the duct or the shooter.

### DETAILED DESCRIPTION OF EMBODIMENTS

Hereinafter, embodiments of the present disclosure will be described with reference to the drawings.

### First Embodiment

(Entire Structure of Mounting Apparatus 100 and Structures of Units Thereof)

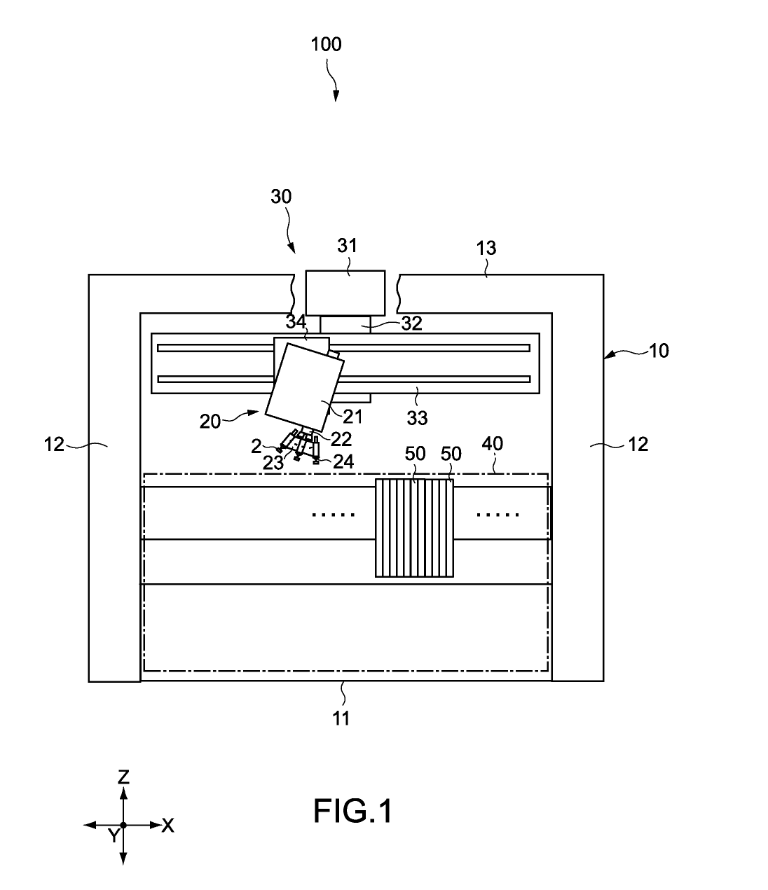

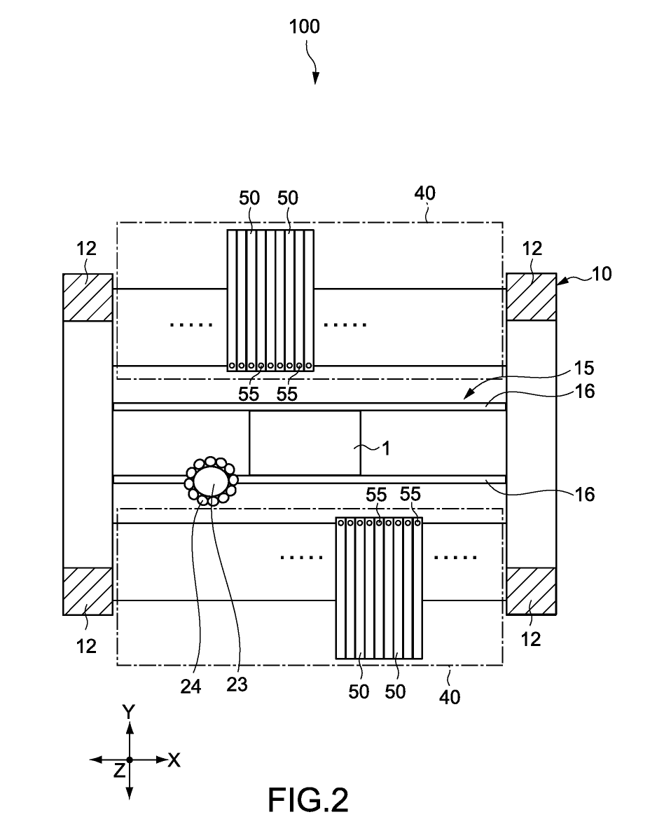

FIG. 1 is a front view showing a mounting apparatus 100, and FIG. 2 is a top view showing the mounting apparatus 100. As shown in FIGS. 1 and 2, the mounting apparatus 100 is provided with a frame structure 10, a conveyance mechanism 15, a mounting head 20, a head movement mechanism 30, and a part supply mechanism 40. The mounting apparatus 100 is further provided with a control unit, a storage unit, and the like (not shown).

The frame structure 10 has a base 11 provided on a bottom portion thereof, four vertical frames 12 fixed to the base 11, and two transverse frames 13 extended over upper portions of the vertical frames 12 along an X axis direction.

The conveyance mechanism 15 is provided along the X axis direction in the mounting apparatus 100 and conveys a substrate 1 in the X axis direction. The conveyance mechanism 15 includes guides 16 provided along the X axis direction, a conveyor belt provided on inner sides of the guides 16, and the like.

The head movement mechanism 30 is a mechanism for moving the mounting head 20 in a horizontal direction (XY directions). The head movement mechanism 30 includes a Y axis frame 31 extended along the Y axis direction with respect to the two transverse frames 13 of the frame structure 10 and a Y axis moving body 32 attached on a lower position of the Y axis frame 31 so as to be movable in the Y axis direction with respect to the Y axis frame 31.

Further, the head movement mechanism 30 includes an X axis frame 33 attached to a side surface of the Y axis moving body 32 and an X axis moving body 34 attached on a side surface position of the X axis frame 33 so as to be slidable in the X axis direction with respect to the X axis frame 33.

The mounting head 20 is attached to the side surface of the X axis moving body 34. The mounting head 20 includes a head casing 21 and a base shaft 22 attached to the head casing 21. Further, the mounting head 20 includes a turret 23 rotatably attached to the base shaft 22 and a plurality of suction nozzles 24 attached to the turret 23 at equal intervals along a circumferential direction of the turret 23.

The plurality of suction nozzles 24 each suck an electronic component 2 supplied from the part supply mechanism 40 and mount the sucked electronic component 2 on the substrate 1. The suction nozzles 24 are moved in a vertical direction at a predetermined timing and rotated around a Z axis at a predetermined timing. The suction nozzles 24 are connected to an air compressor and each suck and release the electronic component 2 in accordance with switching between a negative pressure and a positive pressure of the air compressor.

In FIGS. 1 and 2, as an example of the mounting head 20, the mounting head 20 of a turret rotation type is given, but the form of the mounting head 20 is not particularly limited.

The part supply mechanism 40 is a mechanism for supplying the electronic component 2 to the mounting head 20. The part supply mechanism 40 is provided on both sides of the mounting apparatus 100 in a back-and-forth direction with the conveyance mechanism 15 sandwiched therebetween. The part supply mechanism 40 may be provided on one side of the mounting apparatus 100, that is, on a front side or a rear side thereof. The part supply mechanism 40 includes a plurality of tape cassettes 50 arranged along the X axis direction. The tape cassette 50 is attachable to and detachable from the part supply mechanism 40.

The tape cassettes 50 each accommodate a carrier tape 90 therein. The carrier tape 90 stores a plurality of electronic components. The tape cassette 50 feeds the carrier tape 90 (see, FIG. 6) by step feeding, thereby supplying the electronic components 2 stored in the carrier tape 90 to the suction nozzles 24 of the mounting head 20. On an upper surface of an end portion (on the center side of the mounting apparatus 100) of the tape cassette 50, a supply window 55 is formed, and via the supply window 55, the electronic components 2 are supplied to the suction nozzles 24 of the mounting head 20.

The part supply mechanism 40 may be fixed to the mounting apparatus 100 or may be attachable to and detachable from the mounting apparatus 100 (that is, exchangeable carriage). The structure of the part supply mechanism 40 will be described later in detail.

The control unit performs various operations on the basis of various programs stored in the storage unit and performs overall control of the units of the mounting apparatus 100. The storage unit includes a non-volatile memory in which various programs necessary for processes by the control unit and a volatile memory used as a work area for the control unit.

(Structure of Part Supply Mechanism 40 and the Like)

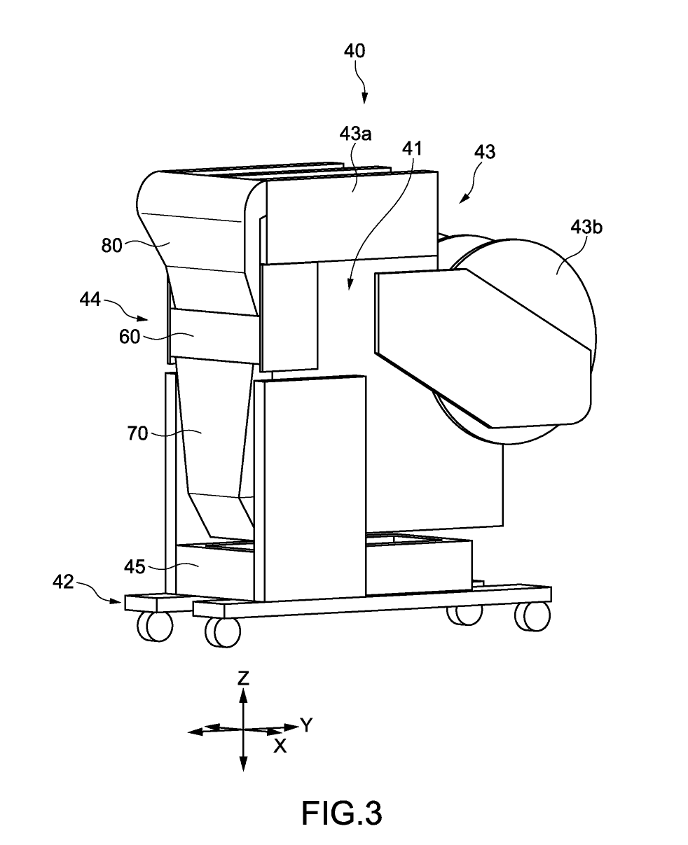

FIG. 3 is a perspective view showing an example of the part supply mechanism 40. It should be noted that in FIG. 3, an example in which the part supply mechanism 40 is attachable to and detachable from the mounting apparatus 100 (that is, exchangeable carriage) is shown. Further, in the example shown in FIG. 3, the state in which the tape cassette 50 is not mounted on the part supply mechanism 40 is shown.

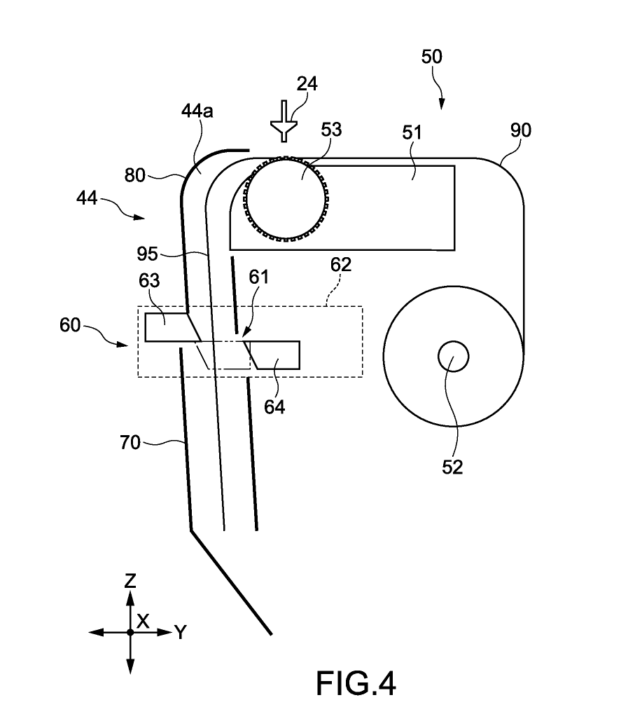

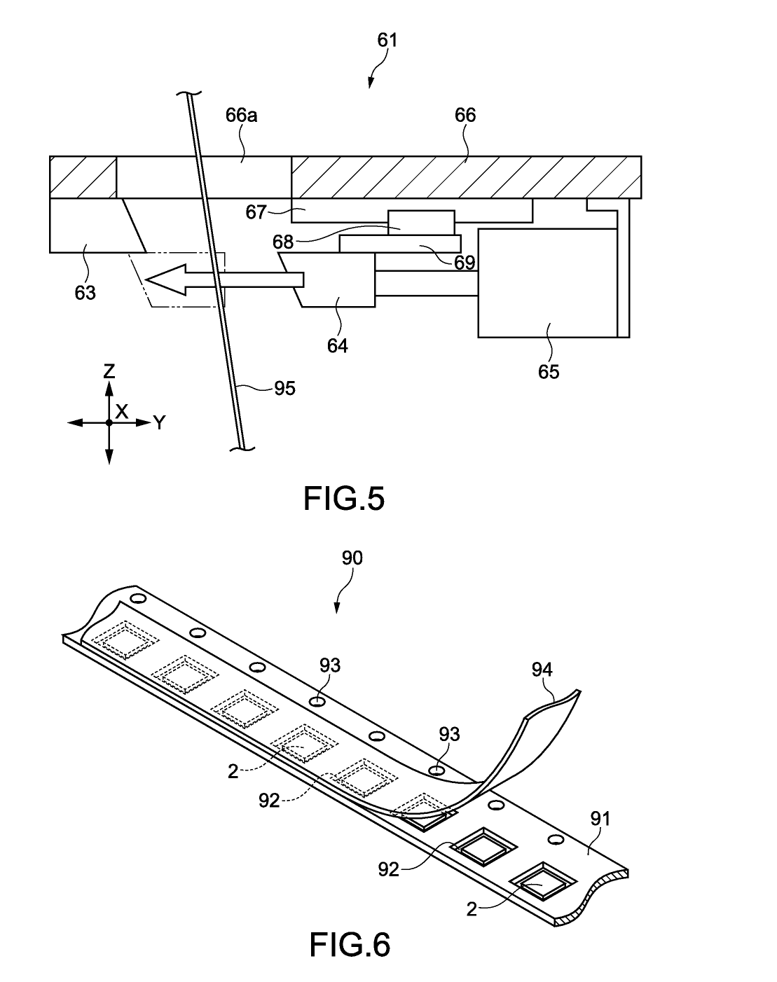

FIG. 4 is a schematic side cross-sectional view showing the part supply mechanism 40. In FIG. 4, the state in which the tape cassette 50 is mounted to the part supply mechanism 40 is shown. FIG. 5 is a side enlarged view of a cutting unit 60 of the part supply mechanism 40. FIG. 6 is a perspective view showing the structure of the carrier tape 90.

(Structure of Carrier Tape 90)

First, with reference to FIG. 6, the structure of the carrier tape 90 will be described. As shown in FIG. 6, the carrier tape 90 stores therein a resistor, a capacitor, an inductor, an IC (integrated circuit) chip, and other electronic components 2 of the same type. The carrier tape 90 includes a carrier tape main body 91 and a cover tape 94 that covers the carrier tape main body 91. The carrier tape 90 is held by a reel 52 (see, FIG. 4) of the tape cassette 50 with the carrier tape 90 wound therearound.

The carrier tape main body 91 has a plurality of grooves 92 for storing the electronic components 2 along a longitudinal direction of the carrier tape 90. Further, on one side portion of the carrier tape main body 91, engagement holes 93 that penetrate the carrier tape main body in the vertical direction are formed along the side portion. The engagement holes 93 are engaged with teeth (see, FIG. 4) of a sprocket 53 of the tape cassette 50.

The cover tape 94 is bonded to the upper surface of the carrier tape main body 91 and can be peeled from the upper surface of the carrier tape main body 91 when a given force or a stronger force than that is applied thereto.

(Structure of Cassette Tape)

Next, with reference to FIG. 4, the structure of the tape cassette 50 will be described. As shown in FIG. 4, the tape cassette 50 includes a tape cassette main body 51 for supplying the electronic components 2 stored in the carrier tape 90 to the suction nozzles 24 of the mounting head 20 and the reel 52 that rotatably holds the carrier tape 90 in the wound state.

In the tape cassette main body 51, a feed mechanism that feeds the carrier tape 90 by step feeding is disposed. The feed mechanism includes the sprocket 53 and a motor for rotating the sprocket 53, and the like. The sprocket 53 has a plurality of teeth on an outer circumference thereof, and the engagement holes 93 of the carrier tape 91 are engaged with the teeth.

When the sprocket 53 is rotated, along the rotation of the sprocket 53, the carrier tape 90 is fed to the front side (left side in FIG. 4) of the tape cassette 50. In the vicinity of an upper end portion of the sprocket 53, the supply window 55 for supplying the electronic components 2 is formed (see, FIG. 2). The suction nozzle 24 is moved in the vertical direction when being positioned above the supply window 55, thereby sucking the electronic components 2 supplied to the position of the supply window 55.

The carrier tape 90 from which the electronic components 2 are taken out by the suction nozzle 24 becomes vacant, and the vacant carrier tape 90 is sent to the front side of the tape cassette 50 as a waste tape 95.

In the tape cassette main body 51, a peeling mechanism that peels the cover tape from the carrier tape main body 91, a pulling mechanism that pulls the cover tape peeled toward the rear side (right side in FIG. 4) of the tape cassette 50, and the like (not shown).

(Structure of Part Supply Mechanism 40)

Next, the structure of the part supply mechanism 40 will be described. With reference to FIG. 3, the part supply mechanism 40 includes a supply mechanism main body 41 and a roller mechanism 42 that movably supports the supply mechanism main body 41 from below. Further, the part supply mechanism 40 includes a cassette attachment unit 43 provided on an upper position of the supply mechanism main body 41, a discharge mechanism 44 provided on the front side (left side in FIG. 3) of the supply mechanism main body 41, and a dust box 45 provided on a lower position of a lower position of the supply mechanism main body 41.

The cassette attachment unit 43 has the structure in which the tape cassette 50 is attachable thereto and detachable therefrom. The cassette attachment unit 43 includes a cassette attachment portion 43a provided on the upper portion of the supply mechanism main body 41 and a reel attachment portion 43b provided on the rear side (right side in FIG. 3) on the upper portion of the supply mechanism main body 41. To the cassette attachment portion 43a, the tape cassette main body 51 of the tape cassette 50 is attached, and to the reel attachment portion 43b, the reel 52 of the tape cassette 50 is attached (see, FIG. 4).

With reference to FIGS. 3 and 4, the discharge mechanism 44 has a discharge route 44a through which the waste tape 95, which is the vacant carrier tape 90 after the electronic components 2 are taken out therefrom, passes. The discharge route 44a guides the waste tape 95 fed from a front end portion side of the tape cassette 50 to the dust box 45.

On the midway of the discharge route 44a, the cutting unit 60 is provided. The cutting unit 60 includes a cutting portion 61 for cutting the waste tape 95 that passes through the discharge route 44a and a rectangular pipe body 62 that surrounds a periphery of the cutting portion 61. The cutting unit 60 forms a part of the discharge route 44a and is attachable to and detachable from the supply mechanism main body 41 (that is, attachable to and detachable from the discharge route 44a).

For example, the cutting unit 60 is attached to the supply mechanism main body 41 by a screwing method or the like. By removing the screw, the cutting unit 60 can be detached from the supply mechanism main body 41. For example, if the cutting unit 60 is broken, or the cutting unit 60 has to be subjected to maintenance, a user detaches the cutting unit 60 from the supply mechanism main body 41 (discharge route 44a) and repairs the cutting unit 60 or performs maintenance for the cutting unit 60.

As shown in FIG. 5, The cutting portion 61 of the cutting unit 60 includes a fixed blade 63, a movable blade 64 that cuts the waste tape 95 with the waste tape 95 sandwiched between the movable blade 64 and the fixed blade 63, and a drive source 65 (for example, air cylinder) for driving the movable blade 64. The fixed blade 63 is fixed to a lower side of a base plate 66, and the drive source 65 is fixed to the lower side of the base plate 66 through a support member.

On the lower side position of the base plate 66, a guide 67 is extended along the Y axis direction, and on a lower side of the guide 67, a slide member 68 movable along the guide 67 is attached. The movable blade 64 is attached to a lower side position of the slide member 68 through an attachment member 69. With this structure, the movable blade 64 is can be moved along the Y axis direction.

In the base plate 66, an opening 66a for causing the waste tape 95 to pass therethrough is formed. The waste tape 95 that passes through the opening 66a is guided to a gap between the fixed blade 63 and movable blade 64. The waste tape 95 guided to the gap between the fixed blade 63 and the movable blade 64 is sandwiched by the two blades by driving the movable blade 64 and is cut. The movable blade 64 is movable with a predetermined period. The period is appropriately set in accordance with the amount of waste tape 95 fed per unit time.

In the above description, the blades are used as an example of the cutting unit 61. However, the cutting unit 61 is not limited thereto. For example, the cutting unit 61 may have such a form that the waste tape 95 is sandwiched by two rollers, and rotations of the rollers tear off the waste tape 95.

With reference to FIGS. 3 and 4 again, in the discharge route 44a, on an upstream position of the cutting unit 60 (upstream side in a direction in which the waste tape 95 is fed), a shooter 80 (upstream side route member) is provided which forms another part of the discharge route 44a on a position adjacent to the cutting unit 60. The shooter 80 guides the waste tape 95 fed toward the front side of the tape cassette 50 by the tape cassette 50 to the cutting unit 60. The shooter 80 is formed so that an upper portion of the shooter 80 is curved.

In the discharge route 44a, on a downstream position of the cutting unit 60 (downstream side in the direction in which the waste tape 95 is fed), a duct 70 (downstream side route member) is provided which forms another part of the discharge route 44a on a position adjacent to the cutting unit 60. The duct 70 guides the waste tape 95 cut by the cutting unit 60 to the dust box 45. The duct 70 is formed so that on a lower end portion side, a front portion is bent toward the rear side. With this structure, the waste tape 95 is easily collected in the dust box 45.

As described above, in this embodiment, the cutting unit 60 is attachable to and detachable from the supply mechanism main body 41 (discharge route 44a). If the user detaches the cutting unit 60 from the supply mechanism main body 41 (discharge route 44a) to repair the cutting unit 60 or perform maintenance for the cutting unit 60, a gap of the discharge route 44a is generated in a part where the cutting unit 60 is attached.

If the production of the substrate 1 is continued with the gap generated in the discharge route 44a, the waste tape 95 exits the discharge route 44a from the gap. In this case, the waste tape 95 that exits the discharge route 44a may be entangled in another mechanism. In the case where such a problem occurs, unless some measures against the problem are taken, the operation of the mounting apparatus 100 has to be stopped, and the production of the substrate 1 by the mounting apparatus 100 is stopped.

In view of the above, in this embodiment, when the cutting unit 60 is detached from the discharge route 44a, the entire duct 70 is moved toward the gap of the discharge route 44a (i.e., upwards). As a result, a part of the duct 70 can serve as a substitute route member to close the gap of the discharge route 44a.

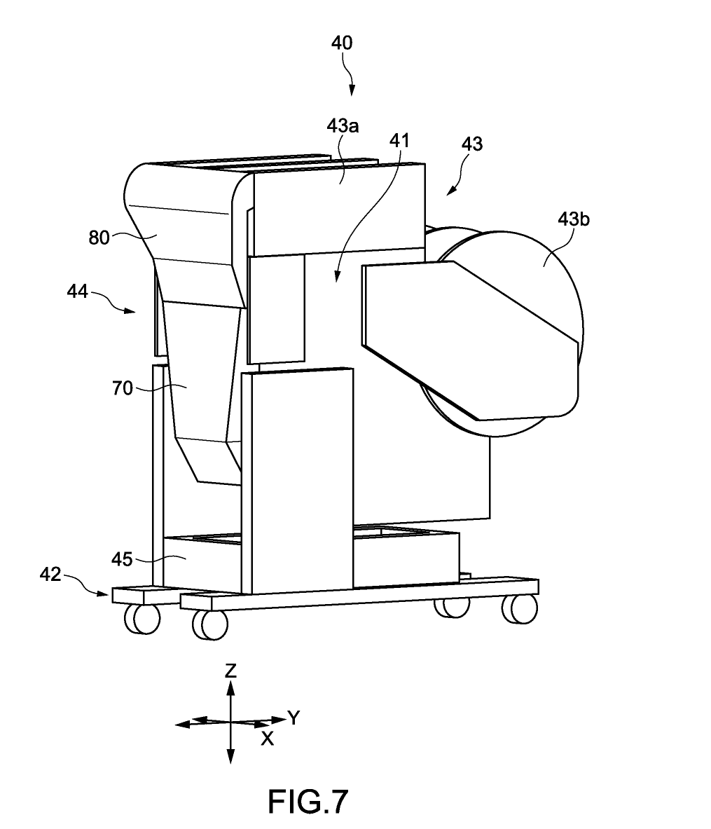

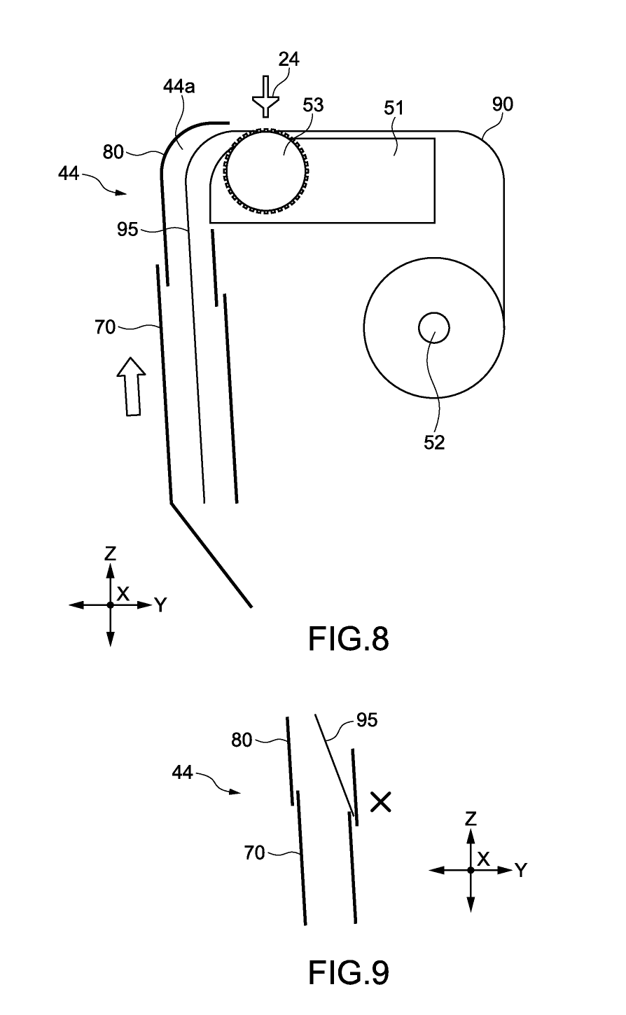

FIG. 7 is a perspective view showing the part supply mechanism 40 and shows a position of the duct 70 when the cutting unit 60 is detached from the supply mechanism main body 41. FIG. 8 is a schematic side cross-sectional view showing the part supply mechanism 40 and shows the position of the duct 70 when the cutting unit 60 is detached from the supply mechanism main body 41.

As can be seen from FIGS. 3, 4, 7, and 8, the duct 70 is disposed on a position (first position) in the case where the cutting unit 60 is attached to the supply mechanism main body 41 or disposed on a different position (second position) in the case where the cutting unit 60 is detached from the supply mechanism main body 41. That is, in the case where the cutting unit 60 is detached, the duct 70 is moved upwards as compared to the case where the cutting unit 60 is attached.

The duct 70 is capable of being fixed to the supply mechanism main body 41 on the second position where the duct 70 is moved upwards. For example, the duct 70 is fixed to the supply mechanism main body 41 by screwing or the like with the duct 70 moved upwards.

In this embodiment, by moving the entire duct 70, it is possible to close the gap of the discharge route 44a. As a result, even in the case where the cutting unit 60 has to be detached from the discharge route 44a, it is possible to secure the discharge route 44a. Consequently, when the cutting unit 60 is detached from the discharge route 44a, the supply of the electronic components 2 from the carrier tape 90 can be continued, and the production of the substrate 1 can be continued. Further, in this embodiment, by moving the entire duct 70, the gap of the discharge route 44a is closed, so it is unnecessary to provide additional substitute route member especially. Thus, it is possible to cut the cost.

Further, as shown in FIG. 8, an inner circumferential size of an upper end portion of the duct 70 is formed to be slightly larger than an outer circumferential size of a lower end portion of the shooter 80. The duct 70 has the structure in which the lower end portion of the shooter 80 enters the inside of the upper end portion of the duct 70 when the duct 70 is moved upwards.

FIG. 9 shows an example in the case where an outer circumferential size of the upper end portion of the duct 70 is formed to be smaller than an inner circumferential size of the lower end portion of the shooter 80. As shown in FIG. 9, in the case where the outer circumferential size of the upper end portion of the duct 70 is formed to be smaller than the inner circumferential size of the lower end portion of the shooter 80, the waste tape 95 may enter a gap between the outer circumference of the duct 70 and the inner circumference of the shooter 80. This may result in clogging of the discharge route 44a with the waste tape 95.

On the other hand, in this embodiment, because the inner circumferential size of the upper end portion of the duct 70 is larger than the outer circumferential size of the lower end portion of the shooter 80, it is possible to prevent the waste tape 95 from clogging the discharge route 44a.

When the repair or the maintenance for the cutting unit 60 is completed, the duct 70 is moved downwards and returned to the first position. Then, the cutting unit 60 is attached to the supply mechanism main body 41 (discharge route 44a) again.

The part supply mechanism 40 may have a guide mechanism or the like for moving the duct 70 in the vertical direction. Further, the part supply mechanism 40 may have a mechanism for fixing, when the duct 70 is moved to an appropriate height on the first portion and the second position along the guide, the duct 70 to the height position. Such mechanisms can be attained by a latch mechanism or the like.

### Second Embodiment

Next, a second embodiment of the present disclosure will be described. The second embodiment is different from the first embodiment in the structure of the duct 70. Therefore, the point will be mainly described. It should be noted that in the second embodiment and embodiments subsequent thereto, members having the same structures and functions as those in the first embodiment are denoted by the same reference symbols, and explanation thereof will be omitted or simplified.

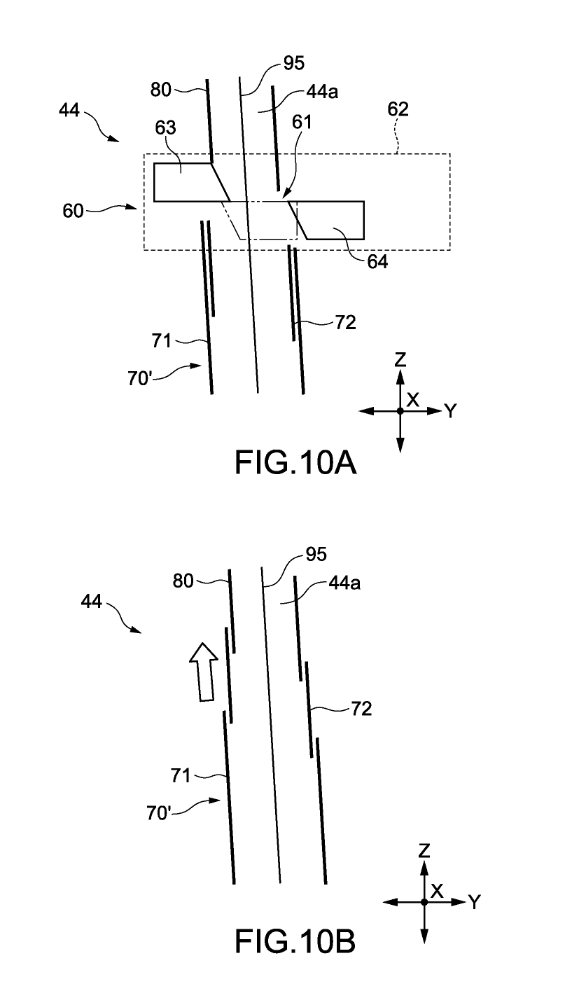

FIG. 10A is a schematic side view showing the discharge mechanism 44 according to the second embodiment and shows the discharge route 44a when the cutting unit 60 is attached. FIG. 10B is a schematic side view showing the discharge mechanism 44 and shows the discharge route 44a when the cutting unit 60 is detached.

As shown in FIG. 10A, a duct 70′ according to the second embodiment forms another part of the discharge route 44a on a downstream position of the cutting unit 60 when the cutting unit 60 is attached to the discharge route 44a. Further, as shown in FIG. 10B, when the cutting unit 60 is detached from the discharge route 44a, a part (movement member 72) of the entire duct 70′ is moved toward a gap of the discharge route 44a (that is, upwards), and the part (movement member 72) serves as a substitute route member to close the gap of the discharge route 44a.

The duct 70′ includes a duct main body 71 (downstream side route member main body) and the movement member 72 provided slidably with respect to the duct main body 71 on an inner circumferential side of the duct main body 71. The movement member 72 has a tubular shape, and a height of the movement member 72 is set to be slightly larger than a height of the cutting unit 60.

An inner circumferential size of an upper end portion of the movement member 72 is formed to be slightly larger than an outer circumferential size of a lower end portion of the shooter 80. The movement member 72 has the structure in which the lower end portion of the shooter 80 enters the inside of the upper end portion of the movement member 72 when the movement member 72 is moved upwards.

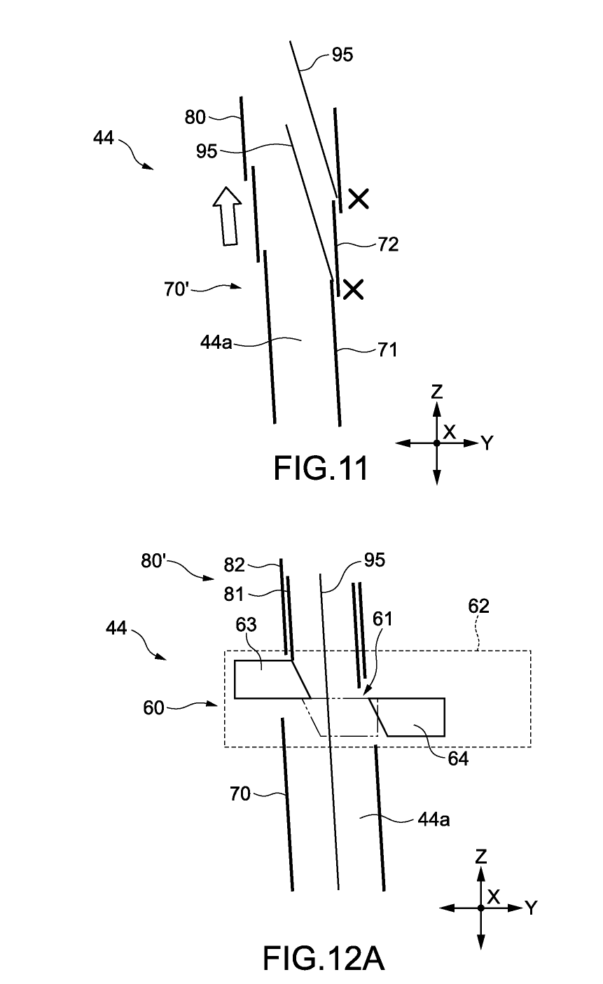

FIG. 11 shows an example in which the outer circumferential size of the upper end portion of the movement member 72 is formed to be smaller than the inner circumferential size of the lower end portion of the shooter 80. As shown in FIG. 11, in the case where the outer circumferential size of the upper end portion of the movement member 72 is formed to be smaller than the inner circumferential size of the lower end portion of the shooter 80, the waste tape 95 may enter a gap between the outer circumference of the movement member 72 and the inner circumference of the shooter 80. If such a problem occurs, the discharge route 44a may be clogged with the waste tape 95.

On the other hand, in this embodiment, because the inner circumferential size of the upper end portion of the movement member 72 is larger than the outer circumferential size of the lower end portion of the shooter 80, it is possible to prevent the waste tape 95 from clogging the discharge route 44a.

Further, FIG. 11 shows an example in the case where the movement member 72 is provided on an outer circumferential side of the duct main body 71. In this case, the waste tape 95 may clog the gap between the outer circumference of the duct main body 71 and the inner circumference of the movement member 72.

On the other hand, in this embodiment, as described above, because the movement member 72 is provided on the inner circumferential side of the duct main body 71, it is possible to prevent the waste tape 95 from clogging the discharge route 44a.

### Third Embodiment

Next, a third embodiment of the present disclosure will be described. The third embodiment is different from the above embodiments in the structure of the shooter 80. Therefore, the point will be mainly described.

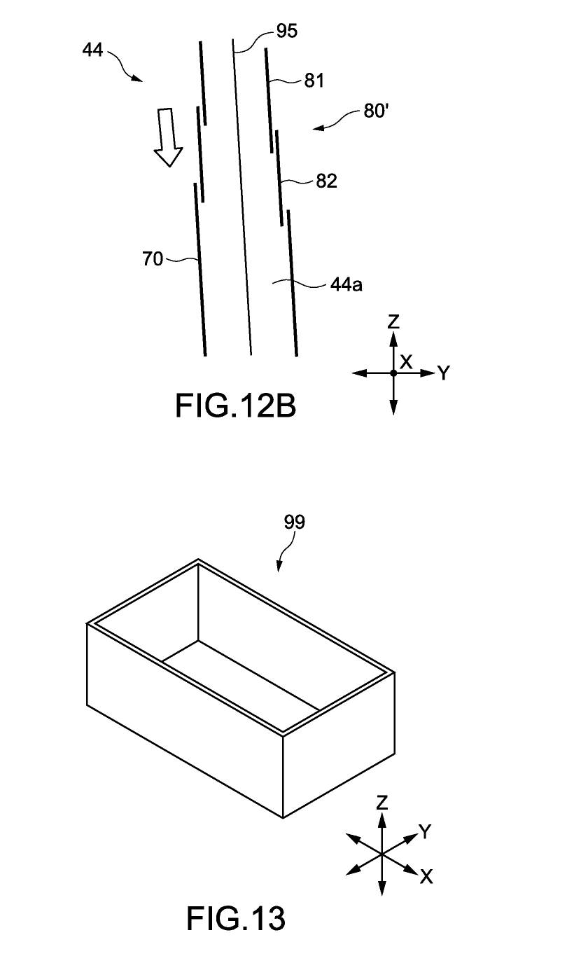

FIG. 12A is a schematic side view showing the discharge mechanism 44 according to the third embodiment and shows the discharge route 44a when the cutting unit 60 is attached. FIG. 12B is a schematic side view showing the discharge mechanism 44 and shows the discharge route 44a when the cutting unit 60 is detached.

As shown in FIG. 12A, a shooter 80′ according to the third embodiment forms another part of the discharge route 44a on an upstream position of the cutting unit 60 when the cutting unit 60 is attached to the discharge route 44a. Further, as shown in FIG. 12B, when the cutting unit 60 is detached from the discharge route 44a, a part (movement member 82) of the entire shooter 80′ is moved toward a gap of the discharge route 44a (that is, downwards), and the part (movement member 82) serves as a substitute route member to close the gap of the discharge route 44a.

The shooter 80′ includes a shooter main body 81 (upstream side route member main body) and the movement member 82 provided slidably with respect to the shooter main body 81 on an outer circumferential side of the shooter main body 81. The movement member 82 has a tubular shape, and a height of the movement member 82 is set to be slightly larger than a height of the cutting unit 60.

An outer circumferential size of a lower end portion of the movement member 82 is formed to be slightly smaller than an inner circumferential size of an upper end portion of the duct 70. The movement member 82 has the structure in which the lower end portion of the movement member 82 enters the inside of the upper end portion of the duct 70 when the movement member 82 is moved downwards.

Here, in the case where the movement member 82 is provided on the inner circumferential side of the shooter main body 81, the discharge route 44a may be clogged with the discharge tape 95 (see, FIG. 11). In the same way, in the case where the inner circumferential size of the lower end portion of the movement member 82 is formed to be larger than the outer circumferential size of the upper end portion of the duct 70, the discharge route 44a may be clogged with the waste tape 95 (see, FIG. 11).

On the other hand, in this embodiment, because the movement member 82 is provided on the outer circumferential side of the shooter main body 81, it is possible to prevent the waste tape 95 from clogging the discharge route 44a. Further, in this embodiment, because the outer circumferential size of the lower end portion of the movement member 82 is formed to be smaller than the inner circumferential size of the upper end portion of the duct 70, it is possible to prevent the waste tape 95 from clogging the discharge route 44a.

### Various Modified Examples

It is also possible to form a part of the duct 70 or the shooter 80 in an accordion shape. In this case, when the cutting unit 60 is detached from the discharge route 44a, the part of the duct 70 or the shooter 80 is moved toward a gap of the discharge route 44a, and the part serves as a substitute route member to close the gap of the discharge route 44a. It should be noted that in the case where the part of the duct 70 or the shooter 80 is formed in the accordion shape, the waste tape 95 may be caught on an accordion-pleated part, and the waste tape 95 may clog the discharge route 44a. Therefore, in this case, it is necessary to appropriately adjust roughness of the accordion-pleated part.

In the above description, the duct 70 or the shooter 80 is used as the substitute route member. The substitute route member may be formed separately from the duct 70 or the shooter 80. FIG. 13 is a diagram showing an example in which the substitute route member is provided separately from the duct 70 or the shooter 80. As shown in FIG. 13, a substitute route member 99 has a tubular shape. The substitute route member 99 is fitted to a gap of the discharge route 44a generated by detaching the cutting unit 60 after the cutting unit 60 is detached.

It should be noted that the present disclosure can take the following configurations.

(1) A discharge mechanism, including:

a discharge route through which a waste tape, which is a carrier tape generated after an electronic component is taken out therefrom, passes;

a cutting unit that has a cutting portion which cuts the waste tape which passes through the discharge route, forms a part of the discharge route, and is capable of being attached to and detached from the discharge route; and

a substitute route member configured to close a gap of the discharge route which is generated when the cutting unit is detached from the discharge route.

(2) The discharge mechanism according to Item (1), in which

the substitute route member serves as a discharge route member so that when the cutting unit is attached to the discharge route, the substitute route member forms another part of the discharge route on a position adjacent to the cutting unit, and when the cutting unit is detached from the discharge route, one of an entire substitute route member and a part thereof is moved toward the gap of the discharge route, and the part thereof closes the gap of the discharge route as the substitute route member.

(3) The discharge mechanism according to Item (2), in which

the discharge route member is a downstream side route member that forms another part of the discharge route on a downstream position of the discharge route from the cutting unit, when the cutting unit is attached to the discharge route.

(4) The discharge mechanism according to Item (3), in which

when the cutting unit is detached from the discharge route, the downstream side route member is entirely moved toward the gap of the discharge route, and a part of the downstream side route member closes the gap of the discharge route as the substitute route member.

(5) The discharge mechanism according to Item (3), in which

the downstream side route member includes
a downstream side route member main body, and
a movement member that is movably provided to the downstream side route member main body and is moved toward the gap of the discharge route to close the gap of the discharge route as the substitute route member, when the cutting unit is detached from the discharge route.

(6) The discharge mechanism according to Item (5), in which

the movement member is provided slidably with respect to the downstream side route member main body.

(7) The discharge mechanism according to Item (6), in which

the movement member is provided on an inner circumferential side of the downstream side route member main body slidably with respect to the downstream side route member main body.

(8) The discharge mechanism according to Item (2), in which

the discharge route member is an upstream side route member that forms another part of the discharge route on an upstream position of the discharge route from the cutting unit, when the cutting unit is attached to the discharge route.

(9) The discharge mechanism according to Item (8), in which

the upstream side route member includes
an upstream side route member main body, and
a movement member that is movably provided to the upstream side route member main body and is moved toward the gap of the discharge route to close the gap of the discharge route as the substitute route member, when the cutting unit is detached from the discharge route.

(10) The discharge mechanism according to Item (9), in which

the movement member is provided slidably with respect to the upstream side route member main body.

(11) The discharge mechanism according to Item (10), in which

the movement member is provided on an outer circumferential side of the upstream side route member main body slidably with respect to the upstream side route member main body.

The present disclosure contains subject matter related to that disclosed in Japanese Priority Patent Application JP 2012-180831 filed in the Japan Patent Office on Aug. 17, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A discharge mechanism, comprising:
a discharge route through which a waste tape, which is a carrier tape generated after an electronic component is taken out therefrom, passes;
a cutting unit that has a cutting portion which cuts the waste tape which passes through the discharge route, forms a part of the discharge route, and is capable of being attached to and detached from the discharge route; and
a substitute route member configured to substitute a gap of the discharge route which is generated when the cutting unit is detached from the discharge route.

2. The discharge mechanism according to claim 1, wherein
the substitute route member serves as a discharge route member so that when the cutting unit is attached to the discharge route, the substitute route member forms another part of the discharge route on a position adjacent to the cutting unit, and when the cutting unit is detached from the discharge route, one of an entire substitute route member and a part thereof is moved toward the gap of the discharge route, and the part thereof substitutes the gap of the discharge route as the substitute route member.

3. The discharge mechanism according to claim 2, wherein
the discharge route member is a downstream side route member that forms another part of the discharge route on a downstream position of the discharge route from the cutting unit, when the cutting unit is attached to the discharge route.

4. The discharge mechanism according to claim 3, wherein
when the cutting unit is detached from the discharge route, the downstream side route member is entirely moved toward the gap of the discharge route, and a part of the downstream side route member substitutes the gap of the discharge route as the substitute route member.

5. The discharge mechanism according to claim 3, wherein
the downstream side route member includes
a downstream side route member main body, and
a movement member that is movably provided to the downstream side route member main body and is moved toward the gap of the discharge route to substitute the gap of the discharge route as the substitute route member, when the cutting unit is detached from the discharge route.

6. The discharge mechanism according to claim 5, wherein
the movement member is provided slidably with respect to the downstream side route member main body.

7. The discharge mechanism according to claim 6, wherein
the movement member is provided on an inner circumferential side of the downstream side route member main body slidably with respect to the downstream side route member main body.

8. The discharge mechanism according to claim 2, wherein
the discharge route member is an upstream side route member that forms another part of the discharge route on an upstream position of the discharge route from the cutting unit, when the cutting unit is attached to the discharge route.

9. The discharge mechanism according to claim 8, wherein
the upstream side route member includes
an upstream side route member main body, and
a movement member that is movably provided to the upstream side route member main body and is moved toward the gap of the discharge route to substitute the gap of the discharge route as the substitute route member, when the cutting unit is detached from the discharge route.

10. The discharge mechanism according to claim 9, wherein
the movement member is provided slidably with respect to the upstream side route member main body.

11. The discharge mechanism according to claim 10, wherein
the movement member is provided on an outer circumferential side of the upstream side route member main body slidably with respect to the upstream side route member main body.

12. A substitute route member closing a gap of a discharge route which is generated when a cutting unit is detached from the discharge route, the cutting unit having a cutting portion that cuts a waste tape as a carrier tape generated after an electronic component is taken therefrom when the waste tape passes through the discharge route, forming a part of the discharge route, and being capable of being attached to and detached from the discharge route.

13. A part supply mechanism, comprising:
a supply mechanism main body configured to supply an electronic component accommodated in a carrier tape; and
a discharge mechanism including a discharge route through which a waste tape, which is a carrier tape generated after an electronic component is taken out therefrom, passes, a cutting unit that has a cutting portion which cuts the waste tape which passes through the discharge route, forms a part of the discharge route, and is capable of being attached to and detached from the discharge route, and a substitute route member that substitutes a gap of the discharge route which is generated when the cutting unit is detached from the discharge route.

14. A method of manufacturing a substitute, comprising:
supplying an electronic component to be mounted on a substrate, the electronic component being accommodated in a carrier tape;
detaching, from a discharge route, a cutting unit that has a cutting portion which cuts a waste tape when the waste tape passes through the discharge route, forms a part of the discharge route, and is capable of being attached to and detached from the discharge route, the waste tape being a carrier tape generated after the electronic component is taken out therefrom by the supplying; and
closing a gap of the discharge route which is generated when the cutting unit is detached from the discharge route by a substitute route member, to continue to manufacture the substrate.
